(19) United States
(12) Patent Application Publication
(10) Pub. No.: US 2013/0216969 A1
(43) Pub. Date: Aug. 22, 2013

(54) Multi-deck Chamber Furnace

(71) Applicant: Rolf-Josef Schwartz, Simmerath (DE)

(72) Inventor: Rolf-Josef Schwartz, Simmerath (DE)

(73) Assignee: Rolf-Josef Schwartz, Simmerath (DE)

(21) Appl. No.: 13/882,937

(22) PCT Filed: Apr. 28, 2011
(86) PCT No.: PCT/EP11/56737

§ 371 Date: May 1, 2013

(30) Foreign Application Priority Data
Nov. 2, 2010 (DE) 102010043229.6

(51) Int. Cl. F27B 17/00; F27B 1/24; F27B 9/02

(52) U.S. Cl. CPC F27B 17/00; F27B 9/028; F27B 1/24
USPC 432/207; 432/238; 432/250

(57) ABSTRACT

The subject innovation relates to a multi-deck chamber furnace for heating up workpieces comprising a furnace housing having at least two horizontal furnace chambers that are arranged vertically one above the other, whereby each furnace chamber has an opening in a furnace wall on one side, and said opening can be closed by a furnace door. The furnace is characterized in that the furnace doors are arranged in front of the openings of the appertaining furnace chambers in such a way that the transversal axes of the furnace doors enclose an angle α with the furnace wall that is greater than 0° and smaller than 45°, whereby the transversal axis of a furnace door runs perpendicular to the horizontal axis of a furnace door. Furthermore, the furnace doors can be moved linearly along these transversal axes.

### CROSS-REFERENCE TO RELATED APPLICATIONS

Pursuant to 35 U.S.C. §371, this application is the United States National Stage Application of International Patent Application No. PCT/EP2011/056737, filed on Apr. 28, 2011, the contents of which are incorporated by reference as if set forth in their entirety herein, which claims priority to European (EP) Patent Application No. 102010043229.6, filed Nov. 2, 2010, the contents of which are incorporated by reference as if set forth in their entirety herein.

### BACKGROUND

Some of the main goals of the automotive industry, not only today but also for the future, include reducing fuel consumption, lowering CO₂ emissions and improving passenger safety. A commonly employed method to reduce fuel consumption and thus to diminish CO₂ emissions is, for instance, the reduction of the vehicle weight. However, in order to concurrently improve passenger safety, the steel grades employed for the car body panels have to be very strong and yet light in weight.

Consequently, there is a growing interest in steel grades for car body panels that exhibit a favorable ratio of strength to weight. This is normally achieved by the process of so-called press hardening or hot stamping. In this process, a sheet metal part is heated up to between 800° C. and 1000° C. [1472° F. and 1832° F.] and subsequently shaped and quenched in a cooled mold. This increases the strength of the part approximately three-fold. Press hardening makes it possible to make lighter and yet stiffer vehicle body panels by combining heat treatment, shaping and, at the same time, controlled cooling.

Normally, such sheet metal parts arranged in packets of up to six individual sheets positioned next to each other and/or behind each other are heated up to the austenitic temperature of about 900° C. [1652° F.] in elongated roller-hearth furnaces or walking-beam furnaces. In the case of an Si-Al coating, the parts are heated up to a diffusion temperature of approximately 950° C. [1742° F]. With an Si-Al coating, there is also a need for a longer retention time of approximately 5 minutes. For these reasons, the requisite furnaces are designed with lengths of up to 40 meters so that they normally entail the drawback that, because of their length, they require a great deal of space. Such installation lengths, however, cannot be accommodated easily and cost-efficiently in modern automotive press shops.

For this reason, in order to save space, it is also a possibility to employ furnaces having several furnace levels arranged horizontally one above the other, which are also referred to as storey furnaces. Here, the individual furnace levels can be provided with drawer elements that are pulled horizontally out of the furnace in order to load and unload the workpieces. German patent specification DE 10 2006 020 781 B3 describes, for example, a storey furnace for heating up steel blanks that has several furnace levels arranged horizontally one above the other, each of which is intended to accommodate at least one steel blank. However, it is also possible to lay several sheet metal parts one above the other on a shelf-like support structure that is provided in a relatively high furnace chamber.

When it comes to such storey furnaces or multi-chamber furnaces into which metal sheets or packets of metal sheets can be laid one above the other, it is extremely important for the height of the individual furnace decks that are arranged above each other to be as small as possible so that the total height of the furnace is still financially feasible for the gripper technology being used. Moreover, the chimney pressure caused by the internal temperature should not become too high. Since oxygen-free inert gas has to be used for uncoated metal sheets, it is also necessary to avoid any air draft through as well as into the furnace. Furthermore, any air draft should also be prevented since otherwise, the temperature in the vicinity of the lower door would cause a heating curve that is impermissible or difficult to control.

The first furnaces of this kind had sliding doors and a continuous interior configured as the furnace chamber. A furnace type with swinging doors on the side had also already existed. These designs, however, have the drawback that sliding doors never seal completely tightly, and that swinging doors cause large volumes of air to move. Moreover, swinging doors require a great deal of space in order to swing open.

### SUMMARY

The subject innovation relates to a multi-deck chamber furnace for heating up workpieces, comprising a furnace housing having at least two horizontal furnace chambers that are arranged vertically one above the other, whereby each furnace chamber has an opening in a furnace wall on at least one side, and said opening can be closed by a furnace door. In particular, such furnaces can be employed to heat up workpieces used in the automotive industry.

Before this backdrop, it is the objective of subject innovation to put forward a multi-deck chamber furnace for heating up sheet metal parts, comprising several furnace levels arranged one above the other as well as a tightly sealing door mechanism, whereby the above-mentioned specifications should also be met.

The multi-deck chamber furnace according to the subject innovation for heating up workpieces comprises a furnace housing having at least two horizontal furnace chambers that are arranged vertically one above the other, whereby each furnace chamber has an opening in a furnace wall on one side, and said opening can be closed by a furnace door. The furnace doors are arranged in front of the openings of the appertaining furnace chambers in such a way that the transversal axes of the furnace doors enclose an angle α with the furnace wall that is greater than 0° and smaller than 45°. Here, the transversal axis of a furnace door runs perpendicular to the horizontal axis of a furnace door. Moreover, according to the subject innovation, the furnace doors can be moved linearly along these transversal axes.

The configuration of the furnace doors for furnace chambers located one above the other makes it possible to create a process-tight door mechanism, irrespective of the dimensions of the furnace and of the furnace chambers, since the slant of the furnace doors means that they can be moved linearly, even in very tight spaces, without one door interfering with the movement of the other. Even if the furnace chambers are designed to be very low, it is possible to provide tightly sealing furnace doors that especially do not cause any air displacement as would be the case, for instance, with swinging doors. This is particularly the case if, except for the uppermost and lowermost furnace doors, each furnace door can be moved linearly along the adjacent furnace door. Consequently, the door construction according to the subject innovation makes it possible to design the furnace chambers to be very low, so that the total height of a furnace can be minimized, with the result that the total height of the furnace is still financially feasible for the gripper technology being used.

Moreover, the door mechanism according to the subject innovation does not require much space and, in particular, there is no need for space in the surroundings of the furnace in order to swing open the doors. Furthermore, since the furnace doors can be moved linearly, any air draft through as well as into the furnace can be avoided, which is not the case, for example, with swinging doors. The furnace doors can nevertheless be designed so as to seal tightly and they also allow partial opening in order to minimize the amount of inert gas that escapes.

In one embodiment of the subject innovation, the furnace chambers are separated from each other by intermediate decks that are detachably installed in the furnace housing. In some embodiments, the intermediate decks rest virtually gas-tight on a support structure that is installed in the furnace housing. This embodiment allows easy assembly of the furnace and the formation of intermediate decks made of a suitable material that can be harmonized with the application in question. For example, the intermediate decks can be configured as radiation-permeable quartz panes that prevent gas from being entrained and mixed inside the furnace, but that allow radiation heat to pass through the intermediate decks. Moreover, the intermediate decks prevent the occurrence of a detrimental chimney pressure inside the furnace housing.

In one embodiment of the subject innovation, such a support structure for holding the intermediate decks can be formed by at least two opposite support beams that are installed on the inner walls of the furnace housing and that extend along the side walls of the furnace housing, whereby each of the intermediate decks rests on two support beams located opposite from each other. Thus, in a simple way, a support structure can be built onto which the intermediate decks can be laid so as to be virtually gas-tight.

In this context, the support beams are configured, for instance, as beams that have a bridge and at least one flange positioned perpendicular to the bridge, whereby the at least one flange runs horizontally and the intermediate decks rest on the at least one flange of a support beam. In some embodiments, the at least one flange on which the intermediate decks rest is arranged at the lower end of a bridge and the intermediate decks each rest on this lower flange of a support beam. Furthermore, the bridges of the support beams can each have at least one recess through which a radiant tube passes for heating the multi-deck chamber furnace, whereby each radiant tube is mounted in the side walls of the furnace housing. In one embodiment, the lower flange of the beams can advantageously be used to create a bearing surface for the intermediate decks, while the radiant tubes for heating up workpieces can be arranged directly above the intermediate decks. If the workpieces are then arranged above the radiant tubes, for example, in that they are laid on the upper flanges of double T-beams, then the radiant tubes can heat up the workpieces from below while the generated heat can also radiate downwards into the next furnace chamber.

In some embodiments, the support structure is made of fiber-reinforced aluminum oxide (Al₂O₃) since this material is lightweight and exhibits a high temperature-resistance.

The furnace doors are driven by an individual drive that is installed, in each case, on a side face of a furnace door and that engages with the associated furnace door. In some embodiments, the movement of the individual drive can be transferred to the opposite side face of a furnace door by a synchronization shaft that extends along the horizontal longitudinal axis of the furnace door. This embodiment constitutes a space-saving solution in comparison to the approach with two drives on both side faces of a furnace door.

Moreover, the furnace door can be made either partially or completely of foam ceramic. Foam ceramic has a low coefficient of heat conductivity and thermal expansion, which entails the advantage that the furnace doors remain dimensionally stable and thus tightly sealed, even when one furnace door is moved in front of another.

Moreover, at least the furnace wall which has the openings can be configured so that it can be cooled for purposes of stabilizing the front of the furnace. For this purpose, a coolant, for example, flows through a pipe system that is arranged in front of and/or inside the furnace wall. Here, the synchronization shaft of each furnace door can run inside this pipe system, at least in certain areas of it, which saves space and protects the synchronization shaft from being exposed to excessive heat so that it does not bend.

Additional advantages, special features and practical refinements of the subject innovation ensue from the subordinate claims and from the presentation below of embodiments making reference to the figures.

### BRIEF DESCRIPTION OF THE DRAWINGS

FIG. 1 illustrates a schematic longitudinal section through an embodiment of the multi-deck chamber furnace;

FIG. 2 illustrates a multi-deck chamber furnace according to FIG. 1, with an open furnace door;

FIG. 3 illustrates a schematic cross section through the multi-deck chamber furnace according to FIG. 1;

FIG. 4 illustrates an enlarged section of a multi-deck chamber furnace according to FIG. 1, with a schematic depiction of an individual drive;

FIG. 5 illustrates a three-dimensional view of a multi-deck chamber furnace, with furnace doors on two sides;

FIG. 6a illustrates a detailed side view of a drive, with closed furnace doors;

FIG. 6b illustrates the detailed view according to FIG. 6a while a furnace door is being opened;

FIG. 7a illustrates a detailed view of a drive with closed furnace doors in a rear view as seen from the inside of the furnace; and

FIG. 7b illustrates the detailed view according to FIG. 7a while a furnace door is being opened.

### DETAILED DESCRIPTION OF SPECIFIC EMBODIMENTS

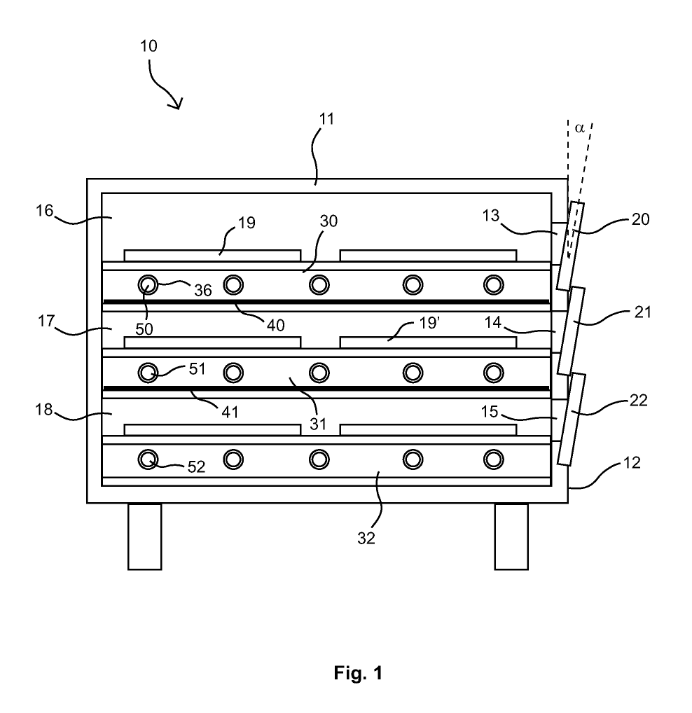

FIG. 1 shows an embodiment of the multi-deck chamber furnace 10 according to the subject innovation, having an outer furnace housing 11 that comprises three furnace chambers 16, 17 and 18. In this context, the furnace chambers 16, 17, 18 each run horizontally and are arranged vertically one above the other, whereby in this embodiment, only three furnace chambers 16, 17, 18 arranged one above the other are shown, but a different number of furnace chambers can also be selected.

Workpieces 19, 19′ are heated in each furnace chamber 16, 17, 18 by a radiant heating tube. Here, several workpieces can be arranged next to each other and/or behind each other inside the furnace chamber, whereby the workpieces can be loaded into the furnace not only individually but also in packets of typically up to six workpieces. The workpieces are, for instance, sheet metal blanks consisting of coated or uncoated steel sheets that are subsequently to be press hardened, whereby the thickness of the metal sheets is in the order of magnitude of 1.5 mm. However, the furnace according to the subject innovation can also be employed for other application purposes.

On at least one side, each furnace chamber is associated with an opening in the furnace wall through which the workpieces can be placed into the furnace 10 in order to be heated and removed after the heating procedure. In this context, each furnace chamber 16, 17, 18 can have just one opening 13, 14, 15 in the right-hand furnace wall 12 through which the workpieces can be placed into the furnace 10 as well as removed from it, as indicated in the embodiment shown in FIG. 1. However, it can also be provided that each furnace chamber has two opposite openings with associated furnace doors, so that the furnace chamber is consistently loaded with workpieces through a feed furnace door, whereas the workpieces are removed via the opposite removal furnace door after the heating procedure.

Each opening 13, 14, 15 of a furnace chamber 16, 17, 18 can be individually closed by a furnace door 20, 21, 22 located on the outside of the furnace wall 12. Here, the transversal axes of the furnace doors 20, 21, 22 run at an angle α relative to the furnace wall 12 that is greater than 0° and smaller than 45°. Consequently, the furnace doors are slanted relative to the furnace wall 12, as seen from the side of the furnace 10.

The term longitudinal axis normally refers to the axis of a body corresponding to the direction of its greatest extension, while the transversal axis of a body runs perpendicular to this longitudinal axis. Typically, as seen from the front of the furnace, the furnace doors would be configured so as to be wider than higher, since the furnace chambers are supposed to have a relatively small height in comparison to their horizontal extension. For this reason, the longitudinal axis of a furnace door would normally extend horizontally, while the transversal axis would run perpendicular to this longitudinal axis at an angle α with respect to the furnace wall 12, that is to say, it would run essentially vertically in spite of the slant. For this subject innovation, however, the transversal axis always refers to the main axis that runs perpendicular to the horizontal main axis of a furnace door, irrespective of the dimensions of the furnace doors. In this context, the axis running in the direction of the thickness of a furnace door should not be taken into consideration.

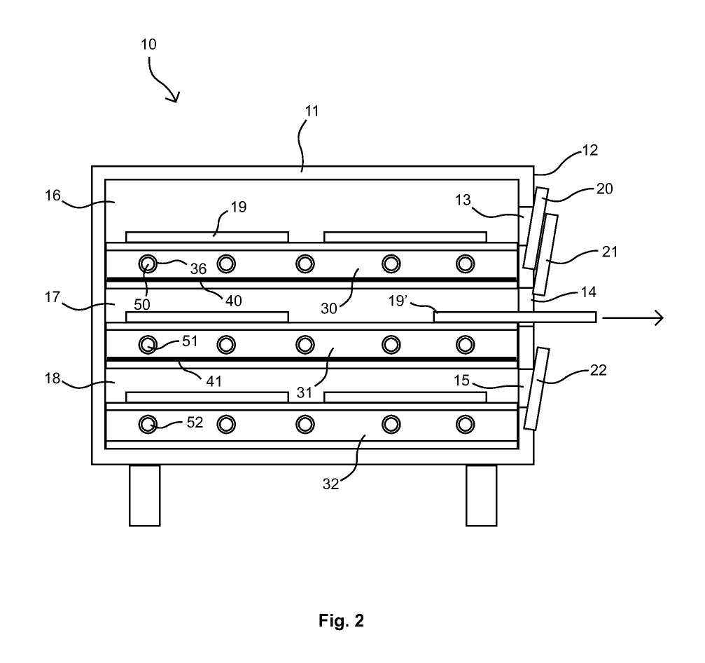

Each furnace door 20, 21, 22 can be moved linearly along this slanted transversal axis by an individual drive, whereby the furnace doors can be moved linearly along an adjacent furnace door. This is shown by way of an example for the middle door 21 in FIG. 2, whereby the middle furnace door 21 was moved linearly upwards along the furnace door 20 located above it in order to free up the opening 14 in the furnace wall 12 located behind the furnace door 20. A workpiece 19′ can now be removed through this opening and a new workpiece can be placed into the furnace.

In the closed state as well, the furnace doors 20, 21, 22 overlap, like shingles, so that the lower area of a furnace door is partially covered by the furnace door located below it. In the embodiment shown in FIG. 1, however, this obviously does not apply to the lowermost furnace door 22, whose lower area remains free since there is not another furnace door located below it. However, the furnace doors can also be arranged in such a way that they are configured so as to be slanted downwards and thus can also be opened downwards in that they are moved linearly downwards. In this case, the arrangement and the overlapping of the furnace doors would be reversed. Such an embodiment would have the advantage that the weight of the furnace doors could be utilized for their movement.

In this context, the furnace doors 20, 21, 22 can all be opened at the same time, or else they can be actuated separately by each individual drive. This arrangement also allows a partial opening of the furnace doors, so that not only inert gas but also radiation heat can be saved.

The shingle-like arrangement of the furnace doors allows the furnace doors to be sealed sufficiently tightly, whereby gaps of about 1 mm between the furnace doors are acceptable and the furnace doors can be considered to be process-tight. In order for the doors not to be exposed to the heat of the inside of a furnace door that is being opened, which could cause them to warp, each furnace door is completely or at least partially made of foam ceramic having a low coefficient of heat conductivity and thermal expansion of about 1×10⁻⁷ K⁻¹. This ensures that the doors remain dimensionally stable and thus tightly sealed, even when one furnace door is moved in front of another one.

The individual furnace chambers 16, 17, 18 are separated from each other by intermediate decks 40, 41 as is shown in FIGS. 1, 2 and 3. Therefore, two intermediate decks 40, 41 are provided for three furnace chambers 16, 17, 18. In some embodiments, however, these intermediate decks 40, 41 are not permanently affixed in the furnace housing 11 but rather, are detachably installed in the furnace housing 11. The intermediate decks 40, 41 rest, for instance, on a support structure inside the furnace housing 11, whereby this support structure can be formed by several support beams.

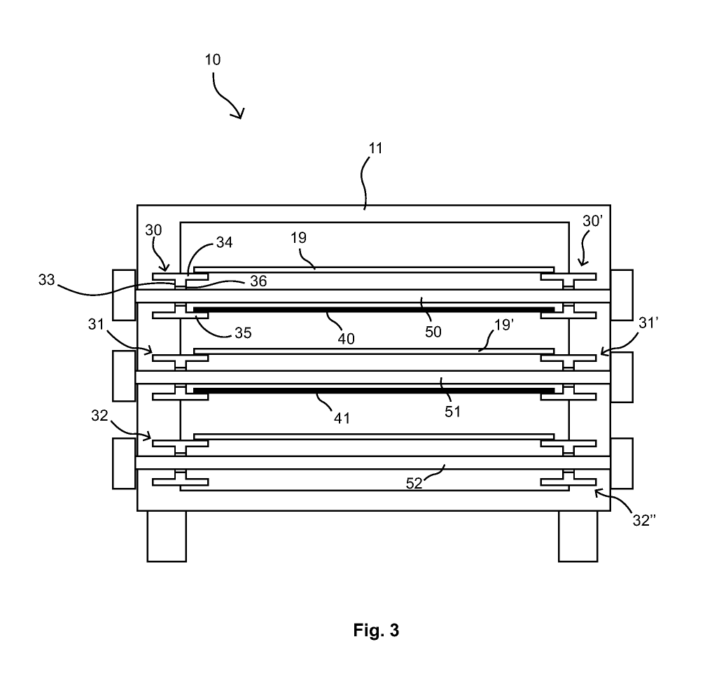

The arrangement and function of the support structure will be described on the basis of FIG. 3, which shows a schematic cross section through a support structure in the form of three support beams 30, 31, 32 and 30′, 31′, 32′ on both sides of the furnace housing 11. These support beams are either installed on the inner wall of the furnace or else placed partially into it, whereby, in each case, two support beams are positioned across from each other at the same height. In some embodiments, these are double T-beams, but it is also possible to employ T-beams with only one flange or other suitable support beams. The flanges 35 of the beams run horizontally and the bridges 33 of the beams run vertically, so that the intermediate decks 40, 41 can be laid onto the flanges.

If double T-beams are employed, as is the case in the embodiment shown in FIG. 3, the intermediate decks 40, 41 rest on the lower flanges 35, whereby, for the sake of simplifying the depiction, only the lower flange of the support beam 30 has been designated by the reference numeral 35. Consequently, the width of the intermediate decks 40, 41 is selected in such a way that, when the furnace 10 is being assembled, they can be placed between two supports and laid onto the lower flanges 35. The dimensions of an intermediate deck that have proven to be advantageous in actual practice are, for example, 500 mm×500 mm A virtually gas-tight seal between the furnace chambers results from the intrinsic weight of the intermediate decks. In this context, a small gap between the intermediate decks and the carrier flanges is acceptable.

However, it is also possible to install additional support beams between the side walls of the furnace chamber in order to reduce the distance between two parallel support beams. This also diminishes the size of the intermediate decks, each of which would then be laid onto two support beams.

In some embodiments, the intermediate decks are quartz glass panes that are highly permeable to radiation in the infrared spectrum. In some embodiments, a permeability of about 98% for infrared radiation is in the range from 700 nm to 2000 nm The configuration of the intermediate decks makes it easy to divide the furnace housing 11 into several furnace chambers, whereby the height of each furnace chamber can be selected to be as small as possible in order to minimize the total height of the furnace 10. The height of one furnace chamber is, for instance, in the order of magnitude of 150 mm to 200 mm.

In one embodiment with double T-beams, in particular, it is possible to lay the workpieces or workpiece packets 19, 19′ directly onto the upper flanges 34 of the support beams if the dimensions of the workpiece permit this. Here, in turn, only the upper flange of the beam 30 bearing the reference numeral 34 was shown in FIG. 3. However, separate structures can also be provided inside the furnace onto which the workpieces can be laid. Moreover, additional cross beams that extend from a left-hand support beam 30, 31, 32 to a right-hand support beam 30′, 31′, 32′ can be installed on the upper flanges 34 of the appertaining support beams. The workpieces can then likewise be laid onto this additional, crosswise support structure, as a result of which several workpieces or workpiece packets can be laid next to each other in order to better utilize the width of the furnace. The same advantage can also be achieved by selecting an embodiment in which there are not only outer beams on the side walls of the furnace but also additional parallel beams between these beams.

Several recesses 36 can be provided in the bridges 33 on the support beams, so that radiant tubes 50, 51, 52 that serve as the heating the furnace 10 can be inserted through such recesses. These radiant tubes 50, 51, 52 are mounted in the side walls of the furnace housing 11 and extend through the recesses 36 into the support beams all the way through the furnace chambers. As a result, the radiant tubes 50, 51, 52 are located in the furnace chambers on one side, below the workpieces, which accounts for a uniform heating of the workpieces. These can be gas-heated radiant tubes or radiant tubes with electric resistance heating, whereby the diameter of the radiant tubes is in the order of magnitude of 50 mm to 150 mm.

This arrangement in which the intermediate decks 40 41 are sealed so as to be virtually gas-tight prevents air oxygen that has entered together with the workpieces 19, 19′ from being entrained and mixed in the adjacent furnace chambers and is nevertheless permeable for the radiation heat of the radiant tubes.

The material normally employed for workpiece carriers in generally known furnaces is heat-resistant stainless steel or brittle ceramic. Metal carriers gradually sag already after a prescribed time-temperature load due to their intrinsic weight and have to be turned over after a short operating time of about half a year, as a result of which the gradual sagging process is reversed. Since this severely ages the steel, this procedure can only be carried out two or three times before the workpiece carrier has to be replaced because of crack formation. Brittle ceramic carriers, in contrast, are destroyed by the slightest impact or shock caused, for example, by the loading device used.

In some embodiments, the support beams 30, 30′, 31, 31′, 32, 32′ are composed of a ceramic fiber-composite material in the form of fiber-reinforced ceramic consisting especially of a fabric made of pure Al₂O₃ fibers with a suitable sintered binder. The specific weight of this composite material is only about one-third that of steel, whereas its temperature resistance is five times higher than that of steel. Moreover, this composite material has the requisite impact and shock resistance for the rough operating conditions encountered, for example, in a press shop.

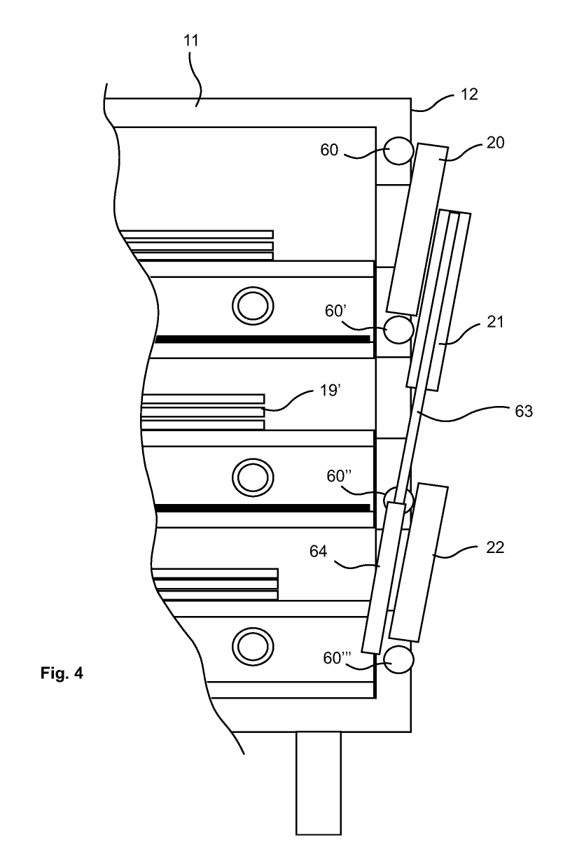

The individual drive used to move the furnace doors linearly along their transversal axis and along an adjacent furnace door can be configured in different ways. In one embodiment, it is an electromotor or pneumatic drive with a piston rod that is accommodated in a cylinder. Such a drive is shown in the schematic detailed view in FIG. 4, whereby, for the sake of simplifying the depiction, only the drive of the middle furnace door 21 is shown, which in FIG. 4 is open. Moreover, the entire drive can be arranged in a housing and/or can have other components, whereby the schematic depiction in FIG. 4 is only meant to illustrate the basic principle of a possible drive.

For the other furnace doors 20 and 22, identical drives can be provided on the same side of the furnace, or else, for space-related reasons, the drives are arranged alternately on different sides of the furnace doors. In the latter case, the drives of the furnace doors 20 and 22 in the view shown in FIG. 4 would thus be arranged on the rear of the furnace and could likewise be identical to the described drive of the furnace door 21.

The piston rod 63 is installed on the furnace door 21 and accommodated in the cylinder 64 located underneath, which is affixed to the furnace housing. Both the cylinder 64 and the piston rod 63 run parallel to the transversal axis of the furnace door 21, so that these are also arranged so as to be slanted with respect to the furnace wall 12. When the piston rod 63 moves, the furnace door 21 moves linearly upwards or downwards, whereby it moves along the furnace door 20 located above it. In addition, guides can be provided for this purpose, so as to assist the linear movement of the furnace doors and to prevent the furnace doors from tilting forward.

Moreover, cooling pipes 60, 60′, 60″ can be provided in the area of the openings 14, 15, 16 in the furnace wall 12, and they serve to convey a coolant such as water, in order to cool the front of the furnace in this area. The cooling pipes 60, 60′, 60″ can be connected to each other in series or else can be supplied with coolant separately from each other.

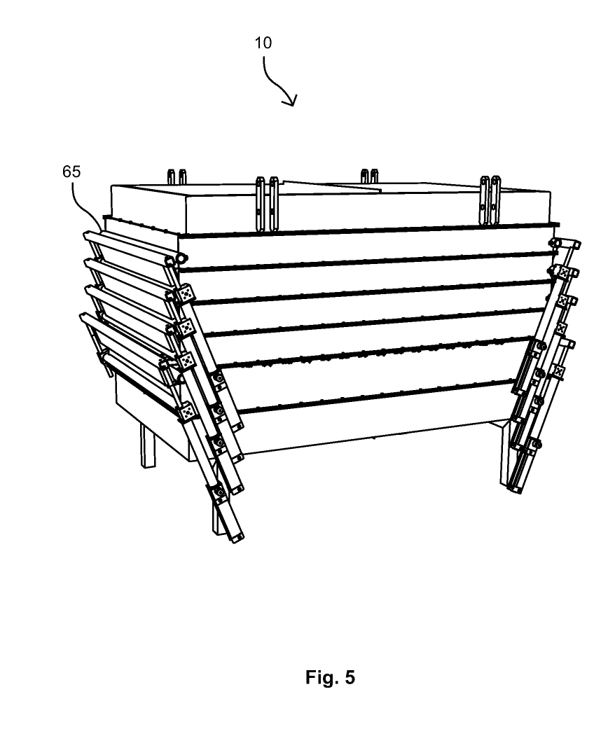

The three-dimensional view of FIG. 5 shows how the drives can be arranged for four furnace doors situated one above the other, whereby, in this embodiment, openings and associated furnace doors are provided on both sides of the furnace 10. The drives with their cylinders and piston rods are arranged one above the other and offset with respect to each other in such a way that each piston rod can move in the associated cylinder and can thus linearly move the furnace door associated with it. In this context, the drives are all arranged on the front as shown in the view in FIG. 5 but, as already mentioned, every second drive can also be arranged on the rear of the furnace 10 for space-related reasons.

In some embodiments, the force of the drive acts on the side face of a furnace door. During operation, however, this could cause a furnace door to be stressed on one side and to thus become deformed. Therefore, in order to allow the force to be transmitted uniformly, the movement of the drive is transmitted via a synchronization shaft 65 to the opposite, other side face of that particular furnace door. Thus, the synchronization shaft 65 runs horizontally along the longitudinal axis of a furnace door, whereby the synchronization shaft 65 is situated in the upper area of the furnace door when the door is closed. In one embodiment of the subject innovation, the appertaining synchronization shaft can run, at least in certain sections, in the cooling pipes of the cooling system for the front of the furnace, which translates into a more compact design and thus into space savings. Moreover, this allows the synchronization shaft to be concurrently cooled so that it does not bend.

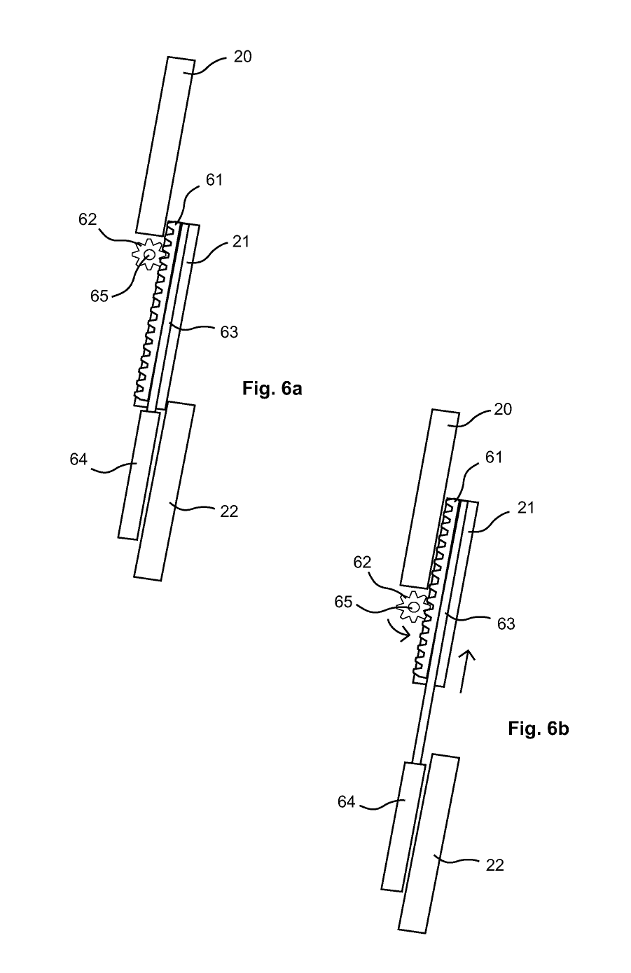

The force can be transmitted via the synchronization shaft, for example, by a rack and pinion gear, as schematically shown in FIGS. 6a and 6b. Here, FIG. 6a shows the middle furnace door 21 and its drive in the closed state, whereby the adjacent furnace doors 20 and 22 are once again shown without a drive. A rack 61 is installed on the furnace door 21 or on the piston rod 63, and this rack 61 runs along the transversal axis of the furnace door 21. This rack intermeshes with a pinion 62 when the furnace door 21 moves by being driven by the piston rod 63. This procedure is indicated by the movement arrows in FIG. 6b, whereby the pinion 62 rotates counterclockwise when the piston rod 63 and thus the rack 61 execute an upwards movement. The pinion 62 is affixed to the synchronization shaft 65, so that it likewise rotates counterclockwise.

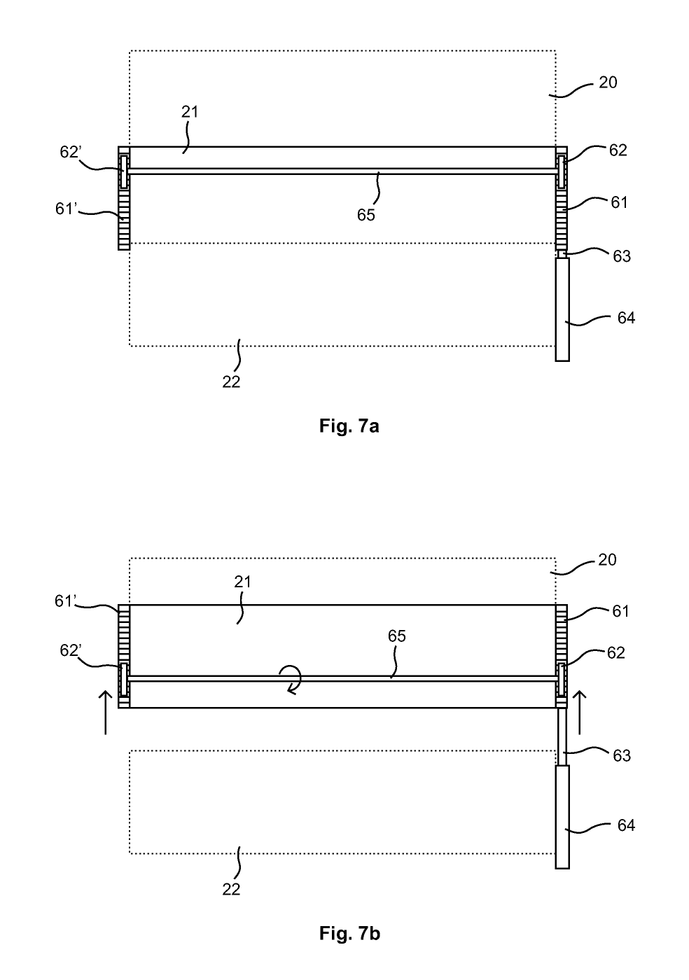

FIGS. 7a and 7b show this force transmission mechanism in a schematic rear view as seen from the inside of the furnace, so that the synchronization shaft 65 of the middle door furnace 21 is in front of the furnace door. The two other furnace doors 20 and 22 are merely indicated by broken lines. The above-mentioned pinion 62 is affixed to the synchronization shaft 65, whereby another pinion 62′ is arranged on the synchronization shaft 65 on the other side of the furnace door 21. On this side, another rack 61′ is also arranged on the furnace door 21 and it intermeshes with the second pinion 62′.

In FIG. 7a, the synchronization shaft 65 of the middle furnace door 21 lies in the upper area of the furnace door 21 when the furnace doors are closed. When the furnace door is then moved upwards by the piston rod 63 as indicated by the arrow, as shown in FIG. 7b, the pinion 62 rotates and this rotation is transmitted via the synchronization shaft 65 to the opposite pinion 62′. Consequently, the opposite rack 61′ also moves upwards and exerts an upwards force onto the other side face of the furnace door 21. Therefore, during movement, a vertical force acts upwards or downwards on both side faces of the furnace door 21, so that the furnace door 21 is uniformly stressed and does not become warped during operation. In order to assist the intermeshing of the pinions 62, 62′ with the racks 61, 61′, guides (not shown here) can be provided that ensure a linear movement of the furnace doors and prevent the pinions from slipping out of the racks.

1-15. (canceled)

16. A multi-deck chamber furnace for heating up workpieces comprising:
a furnace housing;
at least two horizontal furnace chambers of the furnace housing, wherein the furnace chambers are arranged vertically one above the other;
an opening in a furnace wall on one side of each furnace chamber, wherein the opening can be closed a furnace door, wherein the furnace doors are arranged in front of the openings of the appertaining furnace chambers in such a way that the transversal axes of the furnace doors enclose an angle α with the furnace wall that is greater than 0° and smaller than 45°, whereby the transversal axis of a furnace door runs perpendicular to the horizontal axis of a furnace door, and wherein the furnace doors can be moved linearly along these transversal axes.

17. The multi-deck chamber furnace according to claim 16, wherein, except for the uppermost and lowermost furnace doors, each furnace door can be moved linearly along the adjacent furnace door.

18. The multi-deck chamber furnace according to claim 16, wherein the furnace chambers are separated from each other by intermediate decks that are detachably installed in the furnace housing.

19. The multi-deck chamber furnace according to claim 18, wherein the intermediate decks are configured as radiation-permeable quartz panes.

20. The multi-deck chamber furnace according to claim 18, wherein the intermediate decks rest on a support structure that is installed in the furnace housing.

21. The multi-deck chamber furnace according to claim 20, wherein the support structure is made of fiber-reinforced aluminum oxide (Al₂O₃).

22. The multi-deck chamber furnace according to claim 20, wherein a support structure is formed by at least two opposite support beams that are installed on the inner walls of the furnace housing and that extend along the side walls of the furnace housing, whereby each of the intermediate decks rests on two support beams located opposite from each other.

23. The multi-deck chamber furnace according to claim 22, wherein the support beams are configured as beams that have a bridge and at least one flange positioned perpendicular to the bridge, whereby the at least one flange runs horizontally and the intermediate decks rest on the at least one flange of a support beam.

24. The multi-deck chamber furnace according to claim 23, wherein the at least one flange is arranged at the lower end of a bridge and the intermediate decks each rest on this lower flange of a support beam, and wherein the bridges of the support beams each have at least one recess through which a radiant tube passes for heating the multi-deck chamber furnace, whereby each radiant tube is mounted in the side walls of the furnace housing.

25. The multi-deck chamber furnace according to claim 16, wherein, in each case, an individual drive is installed on a side face of a furnace door and it engages with the associated furnace door.

26. The multi-deck chamber furnace according to claim 25, wherein the movement of the individual drive can be transferred to the opposite side face of the furnace door by a synchronization shaft that extends along the horizontal longitudinal axis of the furnace door.

27. The multi-deck chamber furnace according to claim 16, wherein the furnace doors are made either partially or completely of foam ceramic.

28. The multi-deck chamber furnace according to claim 16, wherein at least the furnace wall which has the openings is configured so that it can be cooled.

29. The multi-deck chamber furnace according to claim 28, wherein, in order to cool the furnace wall, a coolant flows through a pipe system that is arranged in front of and/or inside the furnace wall.

30. The multi-deck chamber furnace according to claim 29, wherein the synchronization shaft runs, at least in certain sections, in the cooling pipes for cooling the furnace wall.
